(19) United States
(12) Patent Application Publication
(10) Pub. No.: US 2014/0177853 A1
(43) Pub. Date: Jun. 26, 2014

(54) SOUND PROCESSING DEVICE, SOUND PROCESSING METHOD, AND PROGRAM

(71) Applicant: Sony Corporation, Tokyo (JP)

(72) Inventor: Keisuke Toyama, Tokyo (JP)

(73) Assignee: Sony Corporation, Tokyo (JP)

(21) Appl. No.: 14/132,406

(22) Filed: Dec. 18, 2013

(30) Foreign Application Priority Data
Dec. 20, 2012 (JP) 2012-277662

(51) Int. Cl. H04R 3/00

(52) U.S. Cl. CPC H04R 3/002
USPC 381/58

(57) ABSTRACT

There is provided a sound processing device including a background noise estimation unit configured to estimate a background noise of an input signal, a noise suppression unit configured to suppress the background noise of the input signal based on a result obtained by estimating the background noise, a feature quantity calculation unit configured to calculate a feature quantity based on the input signal in which the background noise is suppressed, and a consonant detection unit configured to detect a consonant from the input signal based on the feature quantity.

### CROSS REFERENCE TO RELATED APPLICATIONS

This application claims the benefit of Japanese Priority Patent Application JP 2012-277662 filed Dec. 20, 2012, the entire contents of which are incorporated herein by reference.

### BACKGROUND

The present technology relates to a sound processing device, a sound processing method, and a program. More particularly, the present technology relates to a sound processing method, sound processing method, and program, capable of detecting a consonant with higher accuracy.

In recent years, with the advance of an aging society, an increasing number of people are suffering from age-related hearing loss. The auditory sensitivity at a high frequency band tends to be deteriorated in the age-related hearing loss, and thus there are many examples where the hearing of voices, especially a consonant becomes difficult.

Thus, as a technique that makes it easier to hear a consonant, there is a technique that enhances a frequency band at which a consonant of an input signal exists by using an equalizer. However, in this technique, enhancement of the frequency band is typically performed regardless of the types of an input signal, and thus, although the consonant is enhanced, the quality of sound other than the consonant is changed, thereby becoming difficult to hear the sound.

Furthermore, with the development of a portable telephone, it becomes able to have a conversation using the portable telephone at anytime, anywhere. However, this also means that a speaker is more likely to be in a noisy environment. A consonant part of a sound signal has relatively less power than a vowel part thereof. Therefore, the articulation of sound is lowered by the fact that a consonant part is buried in noise, and thus a situation where a conversational speech is difficult to hear occurs. Especially, for a person with age-related hearing loss, ease of hearing of sound is known to be affected by the magnitude of background noise, and thus a technique for allowing sound to be easier to hear even in noisy environments is desired.

For example, if noise is large, there is a technique for relatively increasing the SN ratio (Signal to Noise ratio) of sound by reducing noise using a noise suppression technique. However, in this technique, with the increase of the SN ratio, the quality of sound itself will often be changed and the speech articulation or intelligibility tends to be deteriorated. In addition, when a speaker is mumbling with an indistinct speech from the beginning, the noise suppression technique is of no use.

From the above circumstances, it is necessary to provide a technique that detect and enhance a consonant, and techniques for detecting and enhancing a consonant have still been proposed.

As one example of such techniques, there have been proposed techniques that detects and enhances a consonant simply by extracting a plurality of frame signals by a plurality of time frames and by calculating and comparing an average power of the frame signals (for example, refer to Japanese Unexamined Patent Application Publication No. 2010-091897 and Japanese Patent No. 04876245).

### SUMMARY

In the technique disclosed in Japanese Unexamined Patent Application Publication No. 2010-091897 and Japanese Patent No. 04876245, a consonant section or the length of a syllable is previously defined and only a frame corresponding to the definition is regarded as a consonant. However, it is not necessarily that the actual sound is followed by the definition. In particular, its definition varies depending on the language, and thus language dependency of the algorithm will become high.

Furthermore, the detection of a consonant is performed by only the comparison of the power of a frame signal, and thus if the power is changed due to background noise, then it may be difficult to properly detect a consonant.

As mentioned above, in the above-described method of detecting a consonant, for a signal in which noise exists in the background of a consonant, it is difficult to detect the consonant with high accuracy.

An embodiment of the present technology has been made in view of such a situation. It is desirable to detect a consonant with higher accuracy.

According to an embodiment of the present disclosure, there is provided a sound processing device including a background noise estimation unit configured to estimate a background noise of an input signal, a noise suppression unit configured to suppress the background noise of the input signal based on a result obtained by estimating the background noise, a feature quantity calculation unit configured to calculate a feature quantity based on the input signal in which the background noise is suppressed, and a consonant detection unit configured to detect a consonant from the input signal based on the feature quantity.

The background noise estimation unit may estimate the background noise in a frequency domain. The noise suppression unit may obtain a noise suppression spectrum by suppressing the background noise included in an input spectrum obtained from the input signal. The feature quantity calculation unit may calculate the feature quantity based on the noise suppression spectrum.

The background noise estimation unit may estimate the background noise by obtaining an average value of a previous input spectrum.

The sound processing device may further include a consonant enhancement unit configured to enhance the input spectrum for a frequency in which a value of the noise suppression spectrum is greater than a value obtained by multiplying a background noise spectrum by a constant, the background noise spectrum being obtained by estimation of the background noise.

The consonant enhancement unit may enhance the input spectrum with a predetermined enhancement amount.

The sound processing device may further include a consonant enhancement level calculation unit configured to calculate an enhancement amount based on a ratio of a current power of the input signal to an average value of a power of a previous vowel part of the input signal. The consonant enhancement unit may enhance the input spectrum with the enhancement amount.

An interpolation of the enhancement amount may be performed with respect to a frequency direction.

The noise suppression unit may obtain the noise suppression spectrum by using a spectral subtraction method.

A pitch strength of the input signal may further be used as the feature quantity. The consonant detection unit may detect a consonant from the input signal on a basis of the pitch strength as the feature quantity and the feature quantity calculated based on the noise suppression spectrum.

The pitch strength may be represented by a degree to which a peak of the noise suppression spectrum is generated in a position of a pitch frequency and a position of a harmonic frequency of the pitch frequency.

The pitch strength may be an autocorrelation coefficient value of the input signal.

The feature quantity calculation unit may divide a frequency band of the noise suppression spectrum into a plurality sub-bands, and calculates the feature quantity based on a representative value of the noise suppression spectrum in the sub-bands.

The noise suppression spectrum may be a power spectrum.

The noise suppression spectrum may be an amplitude spectrum.

The representative value may be an average value of the noise suppression spectrum in the sub-bands.

The representative value may be a maximum value of the noise suppression spectrum in the sub-bands.

The feature quantity calculation unit may calculate a time difference value between the representative values of the sub-bands in the noise suppression spectrum as the feature quantity.

According to an embodiment of the present disclosure, there is provided a sound processing method including estimating a background noise of an input signal, suppressing the background noise of the input signal based on a result obtained by estimating the background noise, calculating a feature quantity based on the input signal in which the background noise is suppressed, and detecting a consonant from the input signal based on the feature quantity.

According to an embodiment of the present disclosure, there is provided a program for causing a computer to execute a process of estimating a background noise of an input signal, suppressing the background noise of the input signal based on a result obtained by estimating the background noise, calculating a feature quantity based on the input signal in which the background noise is suppressed, and detecting a consonant from the input signal based on the feature quantity.

According to one or more of embodiments of the present disclosure, it is possible to detect a consonant with higher accuracy.

### BRIEF DESCRIPTION OF THE DRAWINGS

FIG. 1 is a diagram illustrating an exemplary configuration of a consonant enhancement device;

FIG. 2 is a diagram for explaining a time-frequency transform;

FIG. 3 is a diagram for explaining the estimation of background noise;

FIG. 4 is a diagram for explaining the calculation of a noise suppression spectrum;

FIG. 5 is a diagram for explaining the calculation of a feature quantity;

FIG. 6 is a diagram for explaining the enhancement of an input spectrum;

FIG. 7 is a diagram illustrating an example of a result obtained by enhancing an input signal;

FIG. 8 is a flowchart for explaining a consonant enhancement process;

FIG. 9 is a flowchart for explaining a consonant detection process;

FIG. 10 is a flowchart for explaining an enhancement amount calculation process;

FIG. 11 is a diagram illustrating another exemplary configuration of the consonant enhancement device;

FIG. 12 is a diagram illustrating another exemplary configuration of the consonant enhancement device;

FIG. 13 is a diagram illustrating another exemplary configuration of the consonant enhancement device;

FIG. 14 is a diagram illustrating an exemplary configuration of the consonant enhancement device;

FIG. 15 is a diagram illustrating another exemplary configuration of the consonant enhancement device; and

FIG. 16 is a diagram illustrating an exemplary configuration of a computer.

### DETAILED DESCRIPTION OF THE EMBODIMENT(S)

Hereinafter, preferred embodiments of the present technology will be described in detail with reference to the appended drawings. Note that, in this specification and the appended drawings, structural elements that have substantially the same function and structure are denoted with the same reference numerals, and repeated explanation of these structural elements is omitted.

### First Embodiment

### Exemplary Configuration of Consonant Enhancement Device

An embodiment of the present technology can be configured to detect a consonant with high accuracy by detecting the consonant based on a signal with suppressed background noise even when there is noise in the background. In addition, an embodiment of the present technology allows the enhancement of a consonant to be properly performed in consideration of noise by determining the amount of enhancement based on the level of an input signal, an estimated background noise, and a noise-suppressed signal.

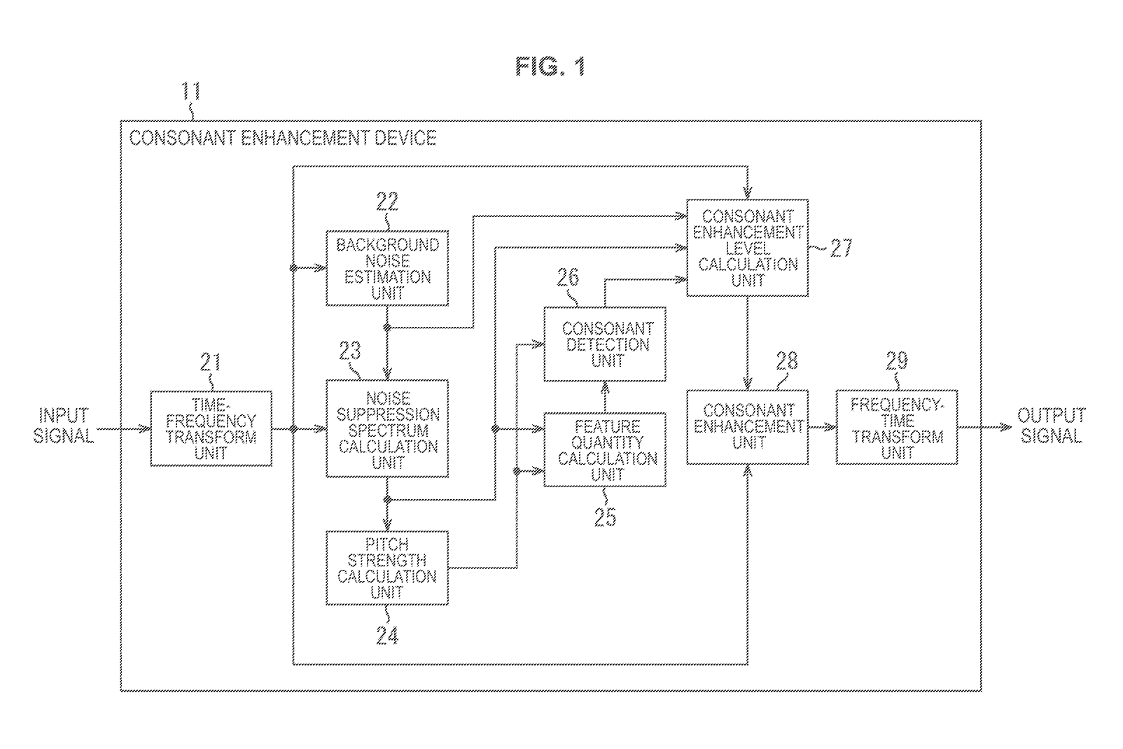

FIG. 1 is a diagram illustrating an exemplary configuration according to an embodiment of a consonant enhancement device to which the present technology is applied.

A consonant enhancement device 11 receives an input signal that is a sound signal, detects a consonant part from the input signal, enhances the consonant based on a result obtained by the detection, and outputs the resulting sound signal as an output signal.

The consonant enhancement device 11 includes a time-frequency transform unit 21, a background noise estimation unit 22, a noise suppression spectrum calculation unit 23, a pitch strength calculation unit 24, a feature quantity calculation unit 25, a consonant detection unit 26, a consonant enhancement level calculation unit 27, a consonant enhancement unit 28, and a frequency-time transform unit 29.

The time-frequency transform unit 21 performs a time-frequency transform on the supplied input signal and supplies the resulting input spectrum to the background noise estimation unit 22, the noise suppression spectrum calculation unit 23, the consonant enhancement level calculation unit 27, and the consonant enhancement unit 28.

The background noise estimation unit 22 estimates background noise based on the input spectrum supplied from the time-frequency transform unit 21 and supplies the resulting background noise spectrum to the noise suppression spectrum calculation unit 23 and the consonant enhancement level calculation unit 27.

The background noise is a noise component such as environmental sound that is different from a voice or the like of a speaker among sound of the input signal. In addition, the background noise spectrum is the spectrum of background noise.

The noise suppression spectrum calculation unit 23 suppresses a background noise component included in the input spectrum based on the input spectrum supplied from the time-frequency transform unit 21 and the background noise spectrum supplied from the background noise estimation unit 22, and obtains a noise-suppression spectrum. The noise suppression spectrum calculation unit 23 supplies the obtained noise suppression spectrum to the pitch strength calculation unit 24, the feature quantity calculation unit 25, and the consonant enhancement level calculation unit 27.

The pitch strength calculation unit 24 calculates pitch strength of the input signal based on the noise suppression spectrum supplied from the noise suppression spectrum calculation unit 23, and supplies the calculated pitch strength to the feature quantity calculation unit 25 and the consonant detection unit 26. In addition, in the following, the case where the pitch strength is obtained from the noise suppression spectrum will be described. However, the pitch strength may be obtained from a spectrum before noise suppression or an input signal that is a signal in the time domain.

The feature quantity calculation unit 25 calculates a feature quantity based on the noise suppression spectrum supplied from the noise suppression spectrum calculation unit 23 or based on the noise suppression spectrum and the pitch strength supplied from the pitch strength calculation unit 24. The feature quantity calculation unit 25 then supplies the calculated feature quantity to the consonant detection unit 26. The feature quantity calculated by the feature quantity calculation unit 25 is used for detecting a consonant from the input signal.

The consonant detection unit 26 detects a consonant section of the input signal based on the pitch strength supplied from the pitch strength calculation unit 24 and the feature quantity supplied from the feature quantity calculation unit 25, and supplies the detection result to the consonant enhancement level calculation unit 27.

More specifically, in the detection of the consonant section, it is specified whether a frame of the input signal to be processed is a frame of the consonant, a frame of the vowel, or other frames, that is, a frame which is neither a consonant nor a vowel. In the following description, a frame of the consonant will be particularly referred to as a consonant frame, and a frame of the vowel will be particularly referred to as a vowel frame.

The consonant enhancement level calculation unit 27 calculates an enhancement amount, based on the input spectrum from the time-frequency transform unit 21, the background noise spectrum from the background noise estimation unit 22, the noise suppression spectrum from the noise suppression spectrum calculation unit 23, and the detection result from the consonant detection unit 26. In other words, the enhancement amount of the frame that is to be a consonant frame by the detection of a consonant is calculated, and then the calculated enhancement amount is supplied from the consonant enhancement level calculation unit 27 to the consonant enhancement unit 28.

The consonant enhancement unit 28 enhances a consonant part of the input spectrum by multiplying the input spectrum supplied from the time-frequency transform unit 21 by the enhancement amount supplied from the consonant enhancement level calculation unit 27, and supplies the input spectrum in which the consonant part is enhanced to the frequency-time transform unit 29.

The frequency-time transform unit 29 performs a frequency-time transform on the input spectrum supplied from the consonant enhancement unit 28 and outputs the resulting output time waveform as an output signal.

<Calculation of Input Spectrum>

Next, a process to be performed by each unit constituting the consonant enhancement device 11 shown in FIG. 1 will now be described.

A process to be performed by the time-frequency transform unit 21 configured to transform an input signal into an input spectrum will now be described.

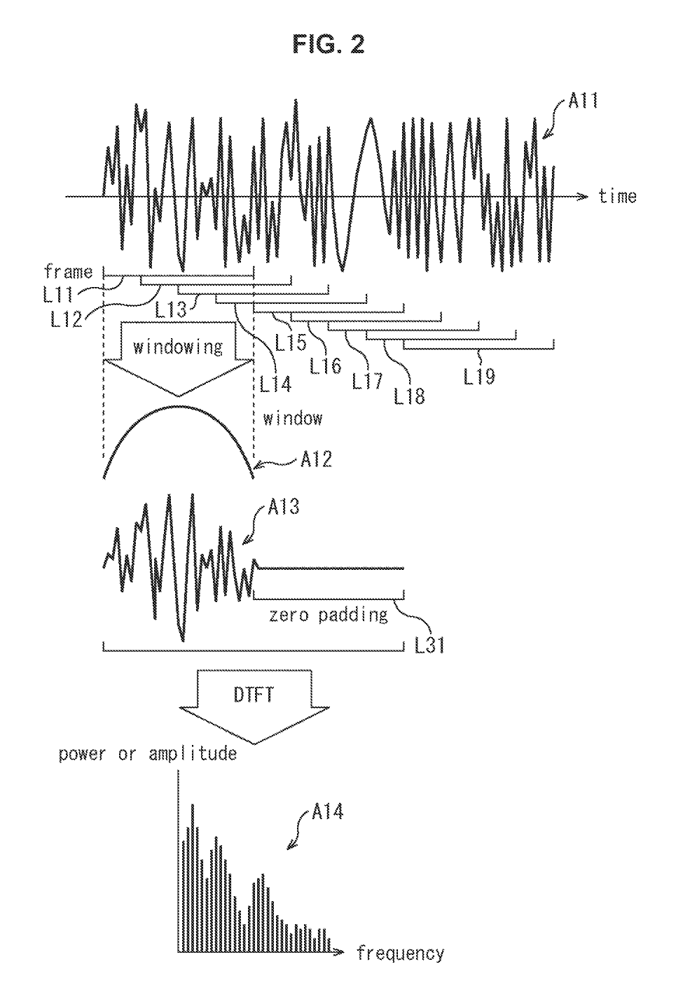

As an example, it is assumed that an input signal with a waveform indicated by an arrow A11 in FIG. 2 is supplied to the time-frequency transform unit 21. In addition, in the input signal indicated by the arrow A11, the horizontal direction represents time and the vertical direction represents amplitude.

When the input signal indicated by the arrow A11 is supplied to the time-frequency transform unit 21, the time-frequency transform unit 21 allows a plurality of predetermined continuous samples constituting the input signal to be combined into a frame. In this example, each of sections L11 to L19 of the input signal corresponds to a single frame.

Furthermore, the time-frequency transform unit 21 performs windowing using a window, that is, a window function with the shape indicated by an arrow A12 for each frame of the input signal. Here, in the window function indicated by the arrow A12, the vertical direction represents a value of the window function, and the horizontal direction represents time, that is, a sample position of the input signal to be multiplied by the value of the window function.

Moreover, the windowing may be performed using a sine window, or may be performed using Hanning window, Hamming window, or the like. However, it is necessary for the windowing to match with when performing the inverse transform in which the frequency signal is transformed back into the time signal.

The time-frequency transform unit 21, when performing the windowing by multiplying each sample constituting the frame of the input signal by a window function, performs zero padding for the resulting signal. For example, if the windowing is performed for the section L11 of the input signal using the window function indicated by the arrow A12 and the zero padding is performed for the resulting signal, then a signal indicated by an arrow A13 is obtained.

In the signal indicated by the arrow A13, the vertical direction represents amplitude and the horizontal direction represents time. In the signal indicated by the arrow A13, a section L31 is a part for which the zero padding is performed, and the amplitude of the signal in this part becomes zero. Additionally, in order to increase frequency resolution for the time-frequency transform in a subsequent stage, the length of the signal after the zero padding may be, for example, two times, four times, or many more times the length of the window.

Furthermore, the time-frequency transform unit 21, after performing the zero padding, performs a time-frequency transform such as discrete Fourier transform on the signal obtained by the zero padding and transforms a time signal into an input spectrum that is a frequency signal. For example, if discrete Fourier transform is performed on the signal indicated by the arrow A13, the input spectrum indicated by an arrow A14 is obtained. In addition, in the input spectrum indicated by the arrow A14, the horizontal direction represents frequency and the vertical direction represents power or amplitude.

In this way, the input spectrum obtained from a frame of the input signal may be a power spectrum, or may be an amplitude spectrum or log magnitude spectrum. In addition, an example of time-frequency transform used to obtain the input spectrum includes, but not limited to discrete Fourier transform, discrete cosine transform, or the like.

Moreover, in the example of FIG. 2, in order to increase frequency resolution, the length of frequency transform is longer than the length of the window by the oversampling due to the zero padding, but the zero padding may not be particularly performed.

The process described above allows an input spectrum to be obtained for each frame of the input signal.

<Estimation of Background Noise>

Subsequently, a description will be given of the estimation of background noise to be performed by the background noise estimation unit 22.

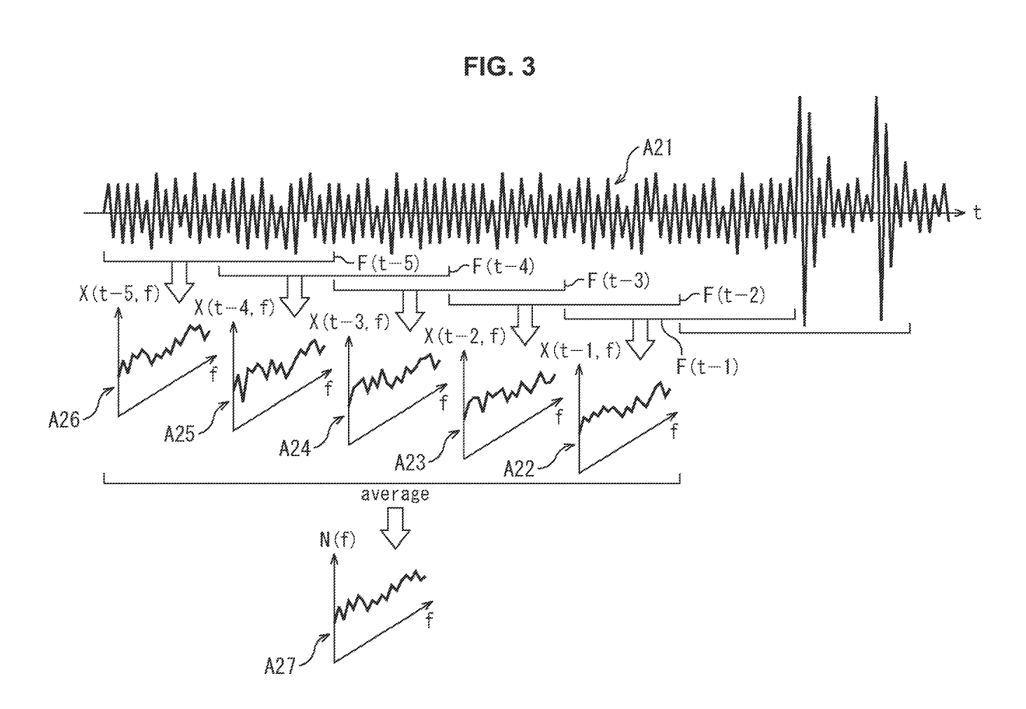

For example, as shown in FIG. 3, in the time-frequency transform unit 21, it is assumed that input spectra X(t−1,f) to X(t−5,f) respectively indicated by arrows 22 to 26 are respectively obtained from five frames F(t−1) to F(t−5) constituting an input signal indicated by an arrow A21. In FIG. 3, in the input signal indicated by the arrow A21, the vertical direction represents amplitude and the horizontal direction represents time. Additionally, in the input spectrum X(t,f) corresponding to each frame, t represents the time index and f represents frequency.

The background noise estimation unit 22 obtains an average value of each of the input spectra X(t−1,f) to X(t−5,f) obtained by the time-frequency transform unit 21 and sets the obtained average value of the input spectra as a background noise spectrum N(t,f). In the example of FIG. 3, the spectrum indicated by an arrow A27 represents the background noise spectrum N(t,f) which is obtained by calculating the average of the input spectra X(t−1,f) to X(t−5,f).

In this way, in the background noise estimation unit 22, the estimation of background noise is performed by setting an average value of input spectra for a predetermined number of previous frames of the input signal as background noise. In general, for a relatively long period of time, by taking an average of the spectrum for each frame of the sound signal, it is known that the average becomes substantially a noise spectrum.

For example, in a case where an average of input spectra for previous M frames is set as a background noise spectrum, the background noise estimation unit 22 calculates the background noise spectrum N(t,f) of a frame at which a time index is set to t, by calculating the following Equation (1).

$$N ( t , f ) = \frac{1}{M} {\sum }_{τ = 1}^{M} X ( t - τ , f ) \qquad ( 1 )$$

In Equation (1), X(t,f) represents the input spectrum of a frame at which the time index is set to t.

Furthermore, when the background noise spectrum is calculated, a frame having large level variation is regarded as a sound signal rather than noise, and thus an input spectrum of the frame may be excluded from the average value calculation process for calculating a background noise spectrum.

A frame having large level variation may be specified, for example, based on the ratio between power of an input spectrum of the frame and power of an input spectrum of its adjacent frame. In addition, a frame having large level variation may be specified by applying threshold processing or the like to an input spectrum.

Moreover, the background noise spectrum may be calculated using, but not limited to the calculation of Equation (1), other methods. For example, instead of setting an average value of input spectra for a predetermined number of previous frames as a background noise spectrum, a background noise spectrum may be updated for each frame to be continuously influenced by the previous frames.

In such a case, for example, the background noise estimation unit 22 calculates the background noise spectrum N(t,f) by calculating the following Equation (2).

$$N ( t , f ) = \frac{{α}_{n} ( f ) N ( t - 1 , f ) + {α}_{x} ( f ) X ( t , f )}{{α}_{n} ( f ) + {α}_{x} ( f )} \qquad ( 2 )$$

In Equation (2), αₙ(f) and αₓ(f) represent predetermined coefficients.

Thus, in Equation (2), a background noise spectrum of a current frame is calculated by a weighted summation of a background noise spectrum of an immediately previous frame and an input spectrum of the current frame. For example, in a case where it is necessary to reduce the contribution degree of a frame having large level variation, a value of the coefficient αₙ(f) may be set to a small value such as zero for the frame having large level variation.

Furthermore, hereinafter, when it is not particularly necessary to distinguish the time index, the background noise spectrum N(t,f) is referred to simply as a background noise spectrum N(f). Similarly, hereinafter, when it is not particularly necessary to distinguish the time index, the input spectrum X(t,f) is referred to simply as an input spectrum X(f).

<Calculation of Noise Suppression Spectrum>

Next, a description will be given of the calculation of the noise suppression spectrum to be performed by the noise suppression spectrum calculation unit 23.

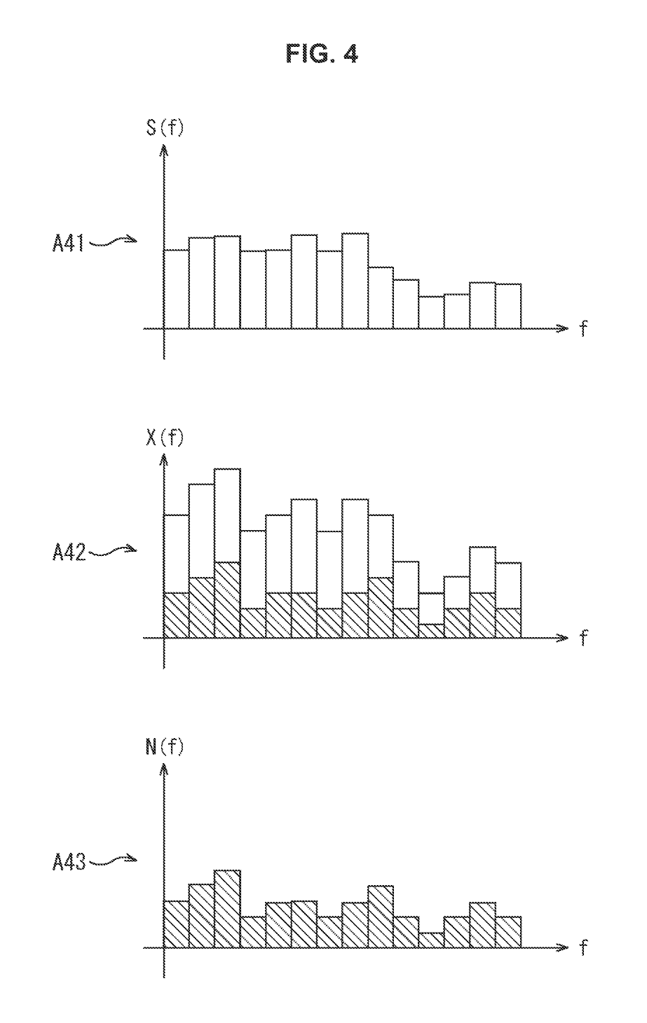

As an example, the noise suppression spectrum is calculated by a spectral subtraction method as shown in FIG. 4.

In FIG. 4, the spectra indicated by arrows A41 to A43 represent a noise suppression spectrum S(f), an input spectrum X(f), and a background noise spectrum N(f), respectively. Additionally, in each spectrum shown in FIG. 4, the vertical axis represents power or amplitude, and the horizontal axis represents frequency.

In the spectral subtraction method, it is assumed that the sum of the noise suppression spectrum S(f) and the background noise spectrum N(f) is the input spectrum X(f). The noise suppression spectrum S(f) is a spectrum of a sound part, and the background noise spectrum N(f) is a component of background noise.

Thus, a spectrum obtained by subtracting the background noise spectrum N(f) from the input spectrum X(f) becomes the noise suppression spectrum S(f) obtained by the estimation. In FIG. 4, the hatched portion in the input spectrum X(f) represents a background noise component included in the input spectrum X(f).

More specifically, the noise suppression spectrum calculation unit 23 calculates the noise suppression spectrum S(f), for example, by calculating the following Equation (3), based on the input spectrum X(f) and the background noise spectrum N(f).

$$S ( f ) = X ( f ) {( 1 - β ( f ) {( \frac{\vert N ( f ) \vert}{\vert X ( f ) \vert} )}^{i} )}^{\frac{1}{i}} \qquad ( 3 )$$

In Equation (3), β(f) is a coefficient which is used to determine the amount of noise suppression, and a value of β(f) may be different for each frequency or may be the same for all frequencies. Additionally, in Equation (3), i is a value which is used to determine the domain of noise suppression.

The noise suppression spectrum S(f) obtained in this way may be a power spectrum or an amplitude spectrum.

<Calculation of Pitch Strength>

Furthermore, a description will be given of the calculation of pitch strength to be performed by the pitch strength calculation unit 24.

The pitch strength is calculated from the noise suppression spectrum S(f).

The pitch strength is represented by how many peaks of the noise suppression spectrum that is a power spectrum or amplitude spectrum are present in a pitch frequency and a harmonic frequency of the pitch frequency. In other words, the pitch strength is represented by the degree to which a peak of the noise suppression spectrum is generated in a position of a pitch frequency and in a position of a harmonic frequency of the pitch frequency.

Thus, the pitch strength is determined based on whether a peak is present in the position of a pitch frequency and whether a peak is present in the position of a harmonic frequency of the pitch frequency, that is, how many harmonic frequencies having a peak are present.

The determination as to whether it is peak or not is made by obtaining a likelihood of being a peak based on the curvature of a spectrum near a peak frequency. In addition, the determination as to whether it is peak or not may be made by obtaining a likelihood of being a peak based on the ratio or difference between a spectrum in a peak frequency and a spectrum in its surroundings or an average value of the surrounding spectrum.

<Calculation of Feature Quantity>

Subsequently, a description will be given of the calculation of a feature quantity to be performed by the feature quantity calculation unit 25.

The feature quantity may be calculated based on the noise suppression spectrum and the pitch strength. However, hereinafter, an example where the feature quantity is calculated based on the noise suppression spectrum will be described.

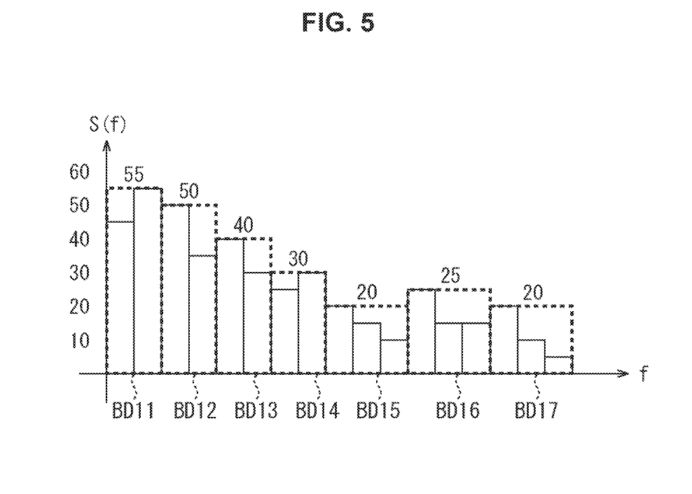

As an example, it is assumed that the noise suppression spectrum S(f) shown in FIG. 5 is supplied from the noise suppression spectrum calculation unit 23 to the feature quantity calculation unit 25. Additionally, in FIG. 5, the vertical axis represents power or amplitude, and the horizontal axis represents frequency.

Moreover, in the noise suppression spectrum S(f), each rectangle represents the value of a spectrum in a single frequency (frequency bin). In this example, the value of the spectrum in seventeen frequency bins is included in the noise suppression spectrum S(f).

If such noise suppression spectrum S(f) is supplied to the feature quantity calculation unit 25, the feature quantity calculation unit 25 divides a frequency band of the noise suppression spectrum S(f) into a plurality of sub-bands. In other words, the frequency band of the noise suppression spectrum S(f) is divided into seven sub-bands BD11 to BD 17 represented by dotted rectangles. For example, two frequency bins at the lowest frequency side are bundled together and it becomes the sub-band BD11.

In a method of dividing into sub-bands, each sub-band may be divided with a uniform width or may be divided with a non-uniform width that simulates an auditory filter. In the example of FIG. 5, each of the sub-bands BD11 to BD 14 is configured to include two frequency bins, and each of the sub-bands BD 15 to BD 17 is configured to include three frequency bins.

Furthermore, for each sub-band that constitutes the noise suppression spectrum S(f), the feature quantity calculation unit 25 sets the maximum value of spectrum values in the sub-bands as a representative value of the sub-band and sets a vector obtained by combining a representative value of each sub-band as a feature quantity of the noise suppression spectrum S(f).

For example, when the representative values of the sub-bands BD 11 to BD 17 are respectively 55, 50, 40, 30, 20, 25, and 20, the vector b={55,50,40,30,20,25,20} which is obtained by sequentially arranging these values is set as a feature quantity.

Here, although the example of setting the maximum value of spectrum values in the sub-bands as a representative value has been described, an average value of spectrum values in sub-bands may be set as a representative value. In addition, as a feature quantity for detecting the onset of consonant, a time differential value of a representative value of each sub-band of the noise suppression spectrum S(f), that is, a differential value of a representative value of the same sub-band for adjacent frames in the time direction may be used.

<Detection of Consonant Frame>

Next, a description will be given of the detection of a consonant frame to be performed by the consonant detection unit 26.

For example, the consonant detection unit 26 determines whether a current frame to be processed of the input signal is a consonant frame by performing a linear discrimination based on the feature quantity supplied from the feature quantity calculation unit 25.

Specifically, for example, the consonant detection unit 26 performs the discrimination by substituting a feature quantity to the linear discriminant Y expressed by the following Equation (4).

$$Y = {\sum }_{n = 1}^{N} {a}_{n} {b}_{n} + {a}_{0} \qquad ( 4 )$$

In Equation (4), aₙ (wherein, 1≦n≦N) and aₒ respectively represent a coefficient and a constant which are learnt in advance. The constant detection unit 26 holds a coefficient vector composed of these coefficient and constant. In addition, bₙ (wherein, 1≦n≦N) represents each element of a vector that is the feature quantity calculated by the feature quantity calculation unit 25.

If the feature quantity supplied from the feature quantity calculation unit 25 is substituted into the linear discriminant Y expressed by Equation (4) and the resulting value is negative, that is, Y=Σaₙbₙ+a₀<0, then the consonant detection unit 26 regards a current frame as a consonant frame.

Furthermore, if a value of the linear discriminant Y is greater than or equal to zero, the consonant detection unit 26 determines whether a current frame is a vowel frame by further determining whether the pitch strength is greater than a threshold value. For example, if the pitch strength is greater than the threshold value, then it is determined that a current frame is a vowel frame. If the pitch strength is less than or equal to the threshold value, then it is determined that a current frame is neither a consonant frame nor a vowel frame, but other frames.

The consonant detection unit 26 supplies information indicating the type of a current frame discriminated in this way to the consonant enhancement level calculation unit 27 as a result of the detection of consonant.

For example, it is known that a peak appears periodically in a spectrum of a vowel frame, and thus whether there is a likelihood of being a vowel frame can be specified based on the pitch strength of an input signal.

The consonant enhancement device 11 obtains pitch strength of an input signal in a frequency domain and thus can calculate pitch strength by selectively using a specific frequency band, such as using only a frequency band at a lower frequency band where a peak is likely to appear. This makes it possible to improve the accuracy of vowel detection.

Furthermore, in the consonant enhancement device 11, although a background noise spectrum in which background noise is suppressed is used to calculate pitch strength, because the noise suppression spectrum is a spectrum in which background noise is suppressed, it becomes possible to detect a peak with higher accuracy.

Besides, as a feature quantity to be used for discriminating a consonant frame, the example of using the feature quantity obtained from the noise suppression spectrum S(f) has been described in the above. However, not only the feature quantity obtained from the noise suppression spectrum S(f) but also the pitch strength may be used as a feature quantity.

In such a case, for example, the pitch strength to be used as a feature quantity may be included as a term in the linear discriminant Y, or a result of detection of consonant obtained by using only the pitch strength may be cascade-connected to the linear discriminant Y. The use of pitch strength to discriminate a consonant frame in this way makes it possible to further improve the accuracy of consonant detection.

Furthermore, as a method of discriminating a consonant, a discrimination method such as a support vector machine or neural net may be used in addition to the linear discriminant.

<Calculation of Enhancement Amount and Enhancement of Input Spectrum>

Moreover, the calculation of an enhancement amount to be performed by the consonant enhancement level calculation unit 27 and the enhancement of an input spectrum to be performed by the consonant enhancement unit 28 will be described.

For example, the consonant enhancement level calculation unit 27 calculates and holds an average value of a power of a previous vowel frame of an input signal as a vowel part power. The power of a vowel frame is set, for example, as an average value or the like of the power for each frequency in an input spectrum of a vowel frame

If a current frame to be processed is a vowel frame, the consonant enhancement level calculation unit 27 updates the vowel part power being held therein.

Specifically, if a current frame is specified as a vowel frame based on the consonant detection result supplied from the consonant detection unit 26, then the consonant enhancement level calculation unit 27 updates the vowel part power based on the vowel part being held and an input spectrum of the current frame supplied from the time-frequency transform unit 21.

If a current frame is specified as a consonant frame based on the consonant detection result supplied from the consonant detection unit 26, then the consonant enhancement level calculation unit 27 calculates an enhancement amount using the vowel part power being held.

For example, the consonant enhancement level calculation unit 27 obtains an average value of the power for each frequency in the input spectrum of the current frame supplied from the time-frequency transform unit 21 and sets the obtained average value as a current frame power. The current frame power is the entire power of the input spectrum. The consonant enhancement level calculation unit 27 then calculates an enhancement amount of the current frame by calculating the following Equation (5).

Enhancement Amount=Vowel Part Power/Current Frame Power (5)

In Equation (5), the ratio (percentage) of an average value of the power of a previous vowel frame to the power of an input spectrum of a current frame is calculated as an enhancement amount. This is because, if the power of a consonant part is enhanced to be the substantially same degree as the power of a vowel part, it becomes easy enough to hear the consonant.

The enhancement amount of the input spectrum may include, but not limited to the value obtained by Equation (5), other values, for example a predetermined constant. In addition, the enhancement amount may be any value of the larger one or the smaller one of the value obtained by Equation (5) and a predetermined constant.

Furthermore, the enhancement amount may be changed depending on the environment that plays back an actual consonant-enhanced sound. For example, in a case of playing back in an environment where it is hard to provide a high frequency band, the enhancement amount may be set to be larger. In an environment where a slightly large high frequency band is originally played back, the enhancement amount may be set to be smaller.

In the consonant enhancement unit 28, the enhancement amount calculated in a way described above is used and enhancement of the input spectrum is performed.

For example, when the enhancement of an input signal is performed, if the enhancement of a spectrum is performed for the entire band of the input signal or a particular fixed band by the same enhancement amount, not only a consonant component but also a noise component will be enhanced. Thus, the enhanced sound will be an uncomfortable sound with high noise sensitivity.

Therefore, the consonant enhancement device 11 is configured not to perform the enhancement for a spectrum in which background noise is dominant.

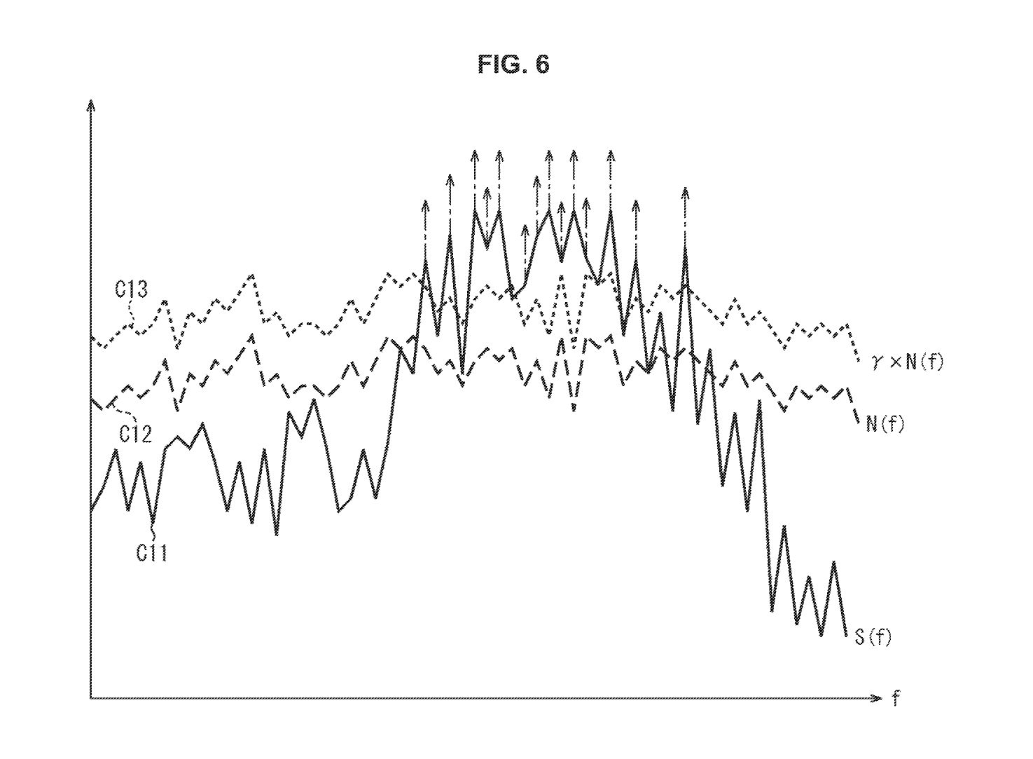

Specifically, for example, as shown in FIG. 6, the consonant enhancement level calculation unit 27 is configured to perform enhancement only when a value of the noise suppression spectrum S(f) is greater than a constant times the value of the background noise spectrum N(f).

In FIG. 6, polygonal lines C11 to C13 represent the noise suppression spectrum S(f), the background noise spectrum N(f), and a background noise spectrum N(f) multiplied by a constant γ, respectively. Additionally, in FIG. 6, the horizontal axis represents frequency and the vertical axis represents power or amplitude.

In the example of FIG. 6, the value of the background noise spectrum N(f) multiplied by the predetermined constant γ, which is indicated by the polygonal line C13 and the value of the noise suppression spectrum S(f), which is indicated by the polygonal line C11 are compared with each other for each frequency. In other words, the consonant enhancement level calculation unit 27 compares the value of the background noise spectrum N(f) multiplied by the constant γ and the value of the noise suppression spectrum S(f), and supplies the comparison result and an enhancement amount to the consonant enhancement unit 28.

In this example, in FIG. 6, in frequencies indicated by arrows pointing upward, the noise suppression spectrum S(f) is greater than a constant γ times the background noise spectrum N(f), and thus the spectrum of this portion are enhanced. The arrow pointing upward represents a state where a frequency component is enhanced.

In this way, the comparison of the noise suppression spectrum S(f) and the background noise spectrum N(f) makes it certain that a frequency band having larger power or amplitude than background noise in a consonant frame is the frequency band including a consonant component, i.e., the frequency band related to the consonant.

Moreover, a frequency band where the noise suppression spectrum S(f) is less than or equal to the constant γ times the background noise spectrum N(f) is a frequency band where the background noise is dominant over other sound such as a consonant, and thus enhancement of the spectrum is not performed.

The consonant enhancement unit 28 multiplies the input spectrum by the enhancement amount only for the frequency in which the value of the noise suppression spectrum S(f) is greater than the value of the background noise spectrum N(f) multiplied by the constant γ, based on the comparison result from the consonant enhancement level calculation unit 27.

Thus, enhancement is not performed for the spectrum in which background noise is dominant, and thus it is possible to enhance a consonant part of the sound so that the quality of the enhanced sound is to be heard in a state where only the consonant is enhanced.

However, if a spectrum in which enhancement is performed is partially missed, there is a possibility that harsh noise called musical noise is generated, and thus it is desirable to perform interpolation of an enhancement amount in the frequency direction. For example, interpolation of an enhancement amount may be performed based on a result obtained by comparing the value of the noise suppression spectrum S(f) and the value of the background noise spectrum N(f) multiplied by the constant γ.

In FIG. 6, the example in which the constant γ is a value greater than 1 has been described in the above, but the constant γ may be less than 1. In addition, the value of the constant γ may be set to be different for each frequency.

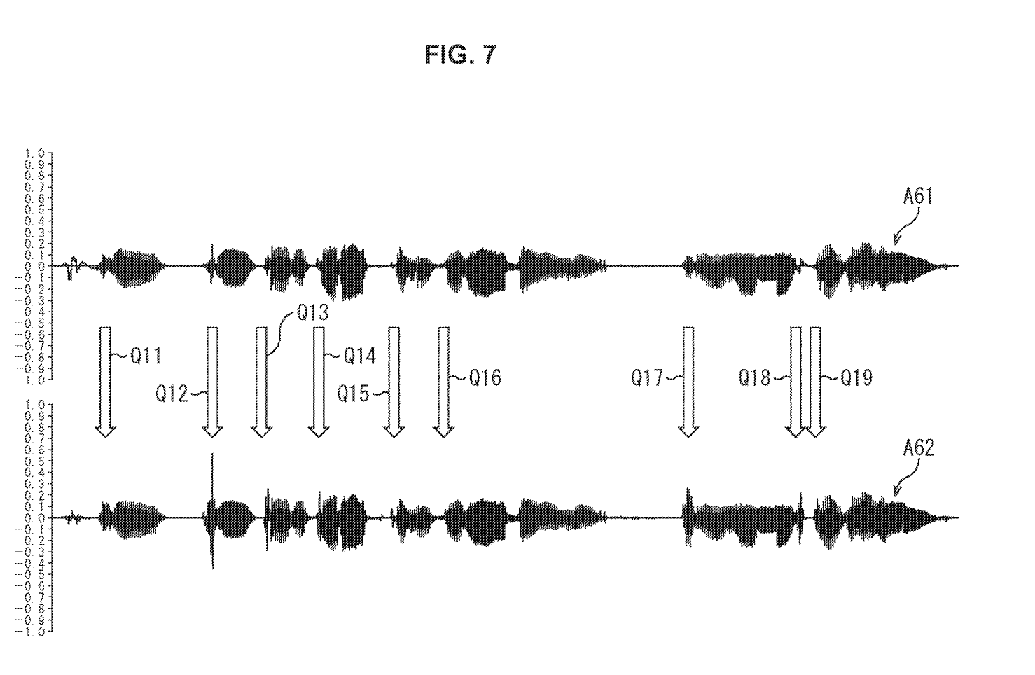

In this way, in a consonant frame, if enhancement of the spectrum is performed for only a band in which background noise is not dominant, an output signal, for example, shown in FIG. 7 is obtained from the enhanced input spectrum. Additionally, in FIG. 7, the vertical axis represents amplitude and the horizontal axis represents time.

In FIG. 7, an arrow A61 indicates a time waveform of an input signal before the enhancement of a consonant part, and an arrow A62 indicates a time waveform of an output signal after the enhancement of a consonant part.

In this example, as indicated by arrows Q11 to Q19, it can be seen that the level of consonant parts of an input signal is enhanced, and, in an output signal, the level of the same part as these consonant parts is greater than an input signal.

In the related art described above, if there is noise in the background, it may be difficult to detect a consonant with high accuracy. On the other hand, the consonant enhancement device 11 obtains a noise suppression spectrum in which the background noise is suppressed and detects a consonant in a frequency band based on a feature quantity obtained by using at least the noise suppression spectrum, thereby making it possible to detect a consonant with higher accuracy.

Furthermore, in the related art, the amplification is performed in the time domain of the sound signal, and thus, if there is noise in the background, then not only a consonant but also noise will be amplified. In this case, if the amplified sound is played back, the sound is heard as if noise rather than a consonant is enhanced. Thus, in the related art, the enhancement with noise taken into consideration is not performed, and thus the sound obtained by such amplification will be heard as if only the noise sensitivity becomes strong.

On the other hand, the consonant enhancement device 11 enhances a frequency band other than the frequency band in which background noise of the consonant frame is dominant in a frequency domain, and thus it is possible to obtain the sound as only a consonant is enhanced. That is, it is possible to perform enhancement of the sound more effectively.

Furthermore, the consonant enhancement device 11 calculates the vowel part power or the current frame power in a frequency domain, and thus the power can be calculated by selectively using a particular frequency band such as excluding a band in which sound is not included other than using the entire band when the power is calculated, thereby performing a process with a high degree of freedom.

<Consonant Enhancement Process>

Meanwhile, when an input signal is supplied to the consonant enhancement device 11 and enhancement for a consonant part of the input signal is instructed, the consonant enhancement device 11 performs a consonant enhancement process and generates an output signal.

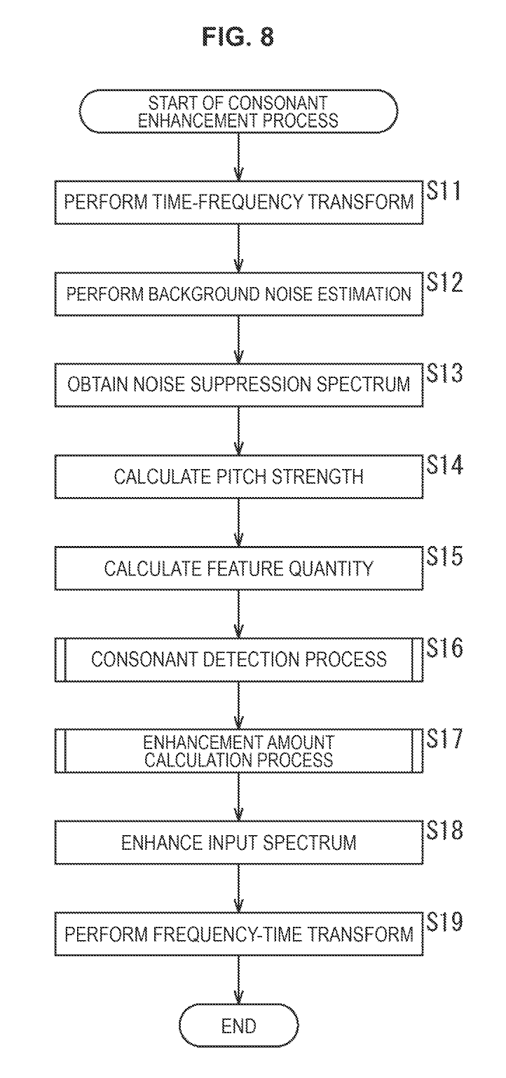

The consonant enhancement process to be performed by the consonant enhancement device 11 will now be described with reference to the flowchart of FIG. 8. In addition, the consonant enhancement process is performed for each frame of the input signal.

In step S11, the time-frequency transform unit 21 performs a time-frequency transform on the supplied input signal, and then supplies the resulting input spectrum to the background noise estimation unit 22, the noise suppression spectrum calculation unit 23, the consonant enhancement level calculation unit 27, and the consonant enhancement unit 28.

For example, a current frame that is the frame to be processed of the input signal is multiplied by a window function, and further a signal multiplied by the window function is subjected to discrete Fourier transform so that the signal is transformed into an input spectrum.

In step S12, the background noise estimation unit 22 performs background noise estimation based on an input spectrum supplied from the time-frequency transform unit 21, and then supplies a background noise spectrum obtained by performing background noise estimation to the noise suppression spectrum calculation unit 23 and the consonant enhancement level calculation unit 27.

The background noise spectrum N(f) is obtained, for example, by performing the calculation of Equation (1) or Equation (2) described above.

In step S13, the noise suppression spectrum calculation unit 23 obtains a noise suppression spectrum based on the input spectrum supplied from the time-frequency transform unit 21 and the background noise spectrum supplied from the background noise estimation unit 22. The noise suppression spectrum calculation unit 23 then supplies the obtained noise suppression spectrum to the pitch strength calculation unit 24, the feature quantity calculation unit 25, and the consonant enhancement level calculation unit 27. The noise suppression spectrum S(f) is obtained, for example, by performing the calculation of Equation (3) described above.

In step S14, the pitch strength calculation unit 24 calculates pitch strength of the input signal based on the noise suppression spectrum supplied from the noise suppression spectrum calculation unit 23, and then supplies the calculated pitch strength to the feature quantity calculation unit 25 and the consonant detection unit 26.

In step S15, the feature quantity calculation unit 25 calculates a feature quantity at least using the noise suppression spectrum supplied from the noise suppression spectrum calculation unit 23, and then supplies the calculated feature quantity to the consonant detection unit 26. For example, the feature quantity calculation unit 25 sets a vector as a feature quantity. The vector is obtained by dividing the noise suppression spectrum into a plurality of sub-bands and by arranging a representative value of each band as described with reference to FIG. 5.

In step S16, the consonant detection unit 26 specifies the type of a current frame by performing the consonant detection process, and then supplies the result thereof to the consonant enhancement level calculation unit 27.

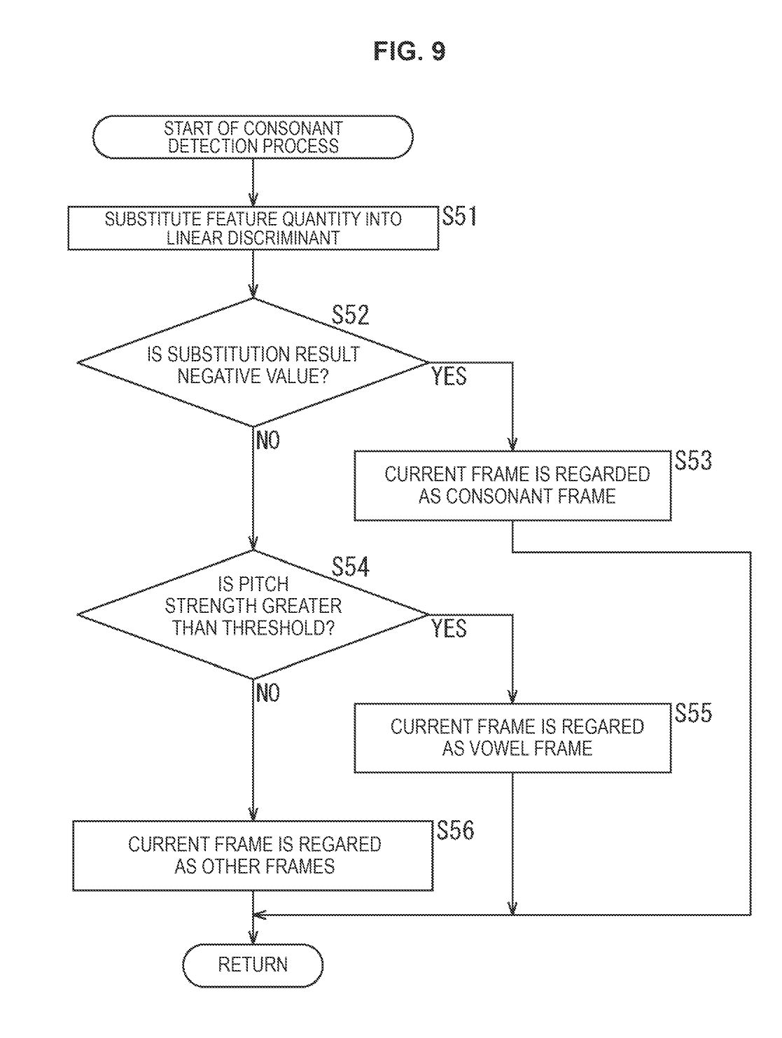

Referring to the flowchart of FIG. 9, the consonant detection process corresponding to the process of step S16 in FIG. 8 will now be described.

In step S51, the consonant detection unit 26 substitutes the feature quantity supplied from the feature quantity calculation unit 25 into a linear discriminant. For example, each element bₙ constituting the feature quantity is substituted into the linear discriminant expressed by Equation (4) described above.

In step S52, the consonant detection unit 26 determines whether a result obtained by substituting the feature quantity into the linear discriminant is a negative value or not.

In step S52, If it is determined that the substitution result is a negative value, in step S53, the consonant detection unit 26 regards a current frame as a consonant frame and supplies the consonant detection result indicating the fact that the current frame is regarded as the consonant frame to the consonant enhancement level calculation unit 27. When the consonant detection result is supplied to the consonant enhancement level calculation unit 27, the consonant detection process is terminated, and then the process proceeds to step S17 in FIG. 8.

On the other hand, in step S52, if it is determined that the substitution result is not a negative value, in step S54, the consonant detection unit 26 determines whether the pitch strength supplied from the pitch strength calculation unit 24 is greater than a predetermined threshold value.

In step S54, if it is determined that the pitch strength is greater than a predetermined threshold value, then, in step S55, the consonant detection unit 26 regards a current frame as a vowel frame and supplies the consonant detection result indicating the fact that the current frame is regarded as the vowel frame to the consonant enhancement level calculation unit 27. When the consonant detection result is supplied to the consonant enhancement level calculation unit 27, the consonant detection process is terminated, and then the process proceeds to step S17 in FIG. 8.

Moreover, in step S54, if it is determined that the pitch strength is less than or equal to the predetermined threshold value, then, in step S56, the consonant detection unit 26 regards a current frame as neither a consonant frame nor a vowel frame but other frames. The consonant detection unit 26 then supplies the consonant detection result indicating the fact that the current frame is regarded as other frames to the consonant enhancement level calculation unit 27. When the consonant detection result is supplied to the consonant enhancement level calculation unit 27, the consonant detection process is terminated, and then the process proceeds to step S17 in FIG. 8.

Referring back to the flowchart of FIG. 8, in step S16, if the consonant detection is performed, then, in step S17, the consonant enhancement level calculation unit 27 performs an enhancement amount calculation process and supplies the resulting enhancement amount to the consonant enhancement unit 28.

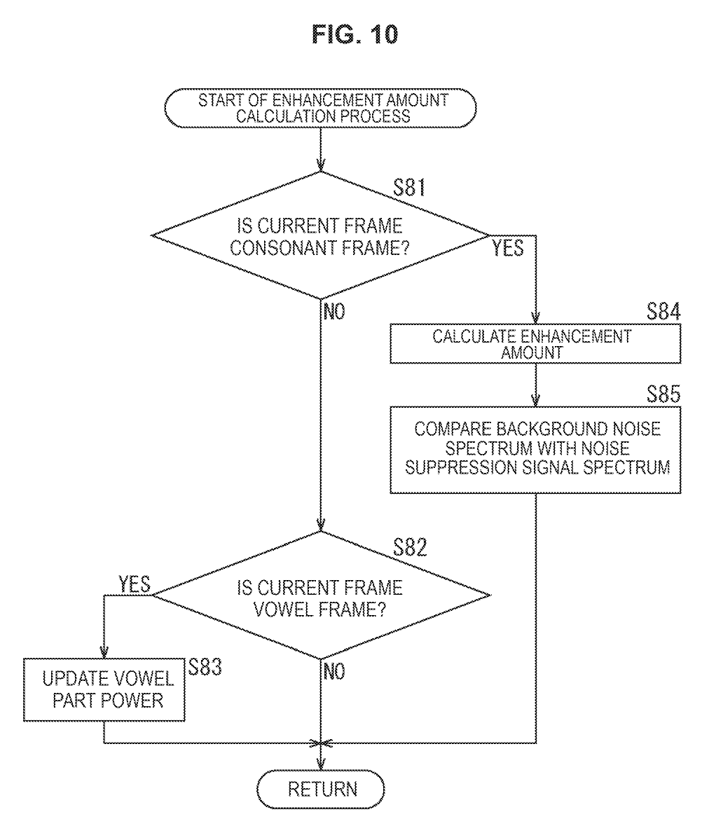

The enhancement amount calculation process corresponding to the process of step S17 in FIG. 8 will now be described with reference to the flowchart of FIG. 10.

In step S81, the consonant enhancement level calculation unit 27 determines whether a current frame is a consonant frame based on the consonant detection result supplied from the consonant detection unit 26.

In step S81, if it is determined that a current frame is not a consonant frame, then, in step S82, the consonant enhancement level calculation unit 27 determines whether a current frame is a vowel frame based on the consonant detection result supplied from the consonant detection unit 26.

In step S82, if it is determined that a current frame is not a vowel frame, that is, it is determined that the current frame is other frames, the enhancement amount calculation process is terminated without outputting an enhancement amount of the input spectrum, and then the process proceeds to step S18 in FIG. 8. In this case, the current frame is not the consonant frame, and thus the enhancement of the input spectrum is not performed in step S18.

Furthermore, in step S82, if it is determined that a current frame is a vowel frame, then, in step S83, the consonant enhancement level calculation unit 27 updates a vowel part power based on the vowel part power being held and the input spectrum supplied from the time-frequency transform unit 21. For example, an average value of the power of an input spectrum of a previous vowel frame including a current frame is set as the updated vowel part power, and it is held in the consonant enhancement level calculation unit 27.

If the vowel part power is updated, the enhancement amount calculation process is terminated, and then the process is proceeds to step S18 in FIG. 8. Even in this case, the current frame is not the consonant frame, and thus the enhancement of the input spectrum is not performed in step S18.

Furthermore, in step S81, if it is determined that a current frame is a vowel frame, a process of step S84 is performed.

In other words, in step S84, the consonant enhancement level calculation unit 27 calculates an enhancement amount based on the vowel part power being held and the input spectrum supplied from the time-frequency transform unit 21, and supplies the calculated enhancement amount to the consonant enhancement unit 28. The enhancement amount is calculated, for example, by performing the calculation of Equation (5) described above.

In step S85, the consonant enhancement level calculation unit 27 compares the background noise spectrum supplied from the background noise estimation unit 22 and the noise suppression spectrum supplied from the noise suppression spectrum calculation unit 23, and supplies the comparison result to the consonant enhancement unit 28.

For example, as described with reference to FIG. 6, the value obtained by multiplying the background noise spectrum N(f) by the constant γ and the value of the noise suppression spectrum S(f) are compared to each other for each frequency.

If the result of the comparison between the background noise spectrum and the noise suppression spectrum is supplied to the consonant enhancement unit 28, the enhancement amount calculation process is terminated, and then the process is proceeds to step S18 in FIG. 8.

Referring back to the flowchart of FIG. 8, in step S18, the consonant enhancement unit 28 enhances the input spectrum by multiplying the enhancement amount supplied from the consonant enhancement level calculation unit 27 by the input spectrum supplied from the time-frequency transform unit 21, and supplies the enhanced input spectrum to the frequency-time transform unit 29.

More specifically, the consonant enhancement unit 28 multiplies a frequency band other than the frequency band in which background noise is dominant over others of the input spectrum by the enhancement amount, based on the comparison result supplied from the consonant enhancement level calculation unit 27.

In addition, if it is determined that a current frame is not a vowel frame, the enhancement of the input spectrum is not performed. The consonant enhancement unit 28 supplies the input spectrum supplied from the time-frequency transform unit 21 to the frequency-time transform unit 29 as it is without any change.

In step S19, the frequency-time transform unit 29 transforms the input spectrum into an output signal that is a time signal by performing a frequency-time transform on the input spectrum supplied from the consonant enhancement unit 28, and outputs the output signal. When the output signal is outputted, the consonant enhancement process is terminated.

As described above, the consonant enhancement device 11 obtains a noise suppression spectrum in which background noise is suppressed, detects a consonant in a frequency domain based on a feature quantity obtained from the noise suppression spectrum, and enhances a consonant frame according to a result obtained by the detection.

In this way, a consonant is detected in a frequency domain using the noise suppression spectrum, thereby detecting the consonant with higher accuracy. In addition, it is possible to perform the sound enhancement more efficiently by enhancing a frequency band other than the frequency band in which background noise of a consonant frame is dominant in a frequency domain.

<Modification 1 of First Embodiment>

<Exemplary Configuration of Consonant Enhancement Device>

While it has been described above that the enhancement amount is calculated based on the input spectrum, the enhancement amount may be calculated in a time domain based on an input signal.

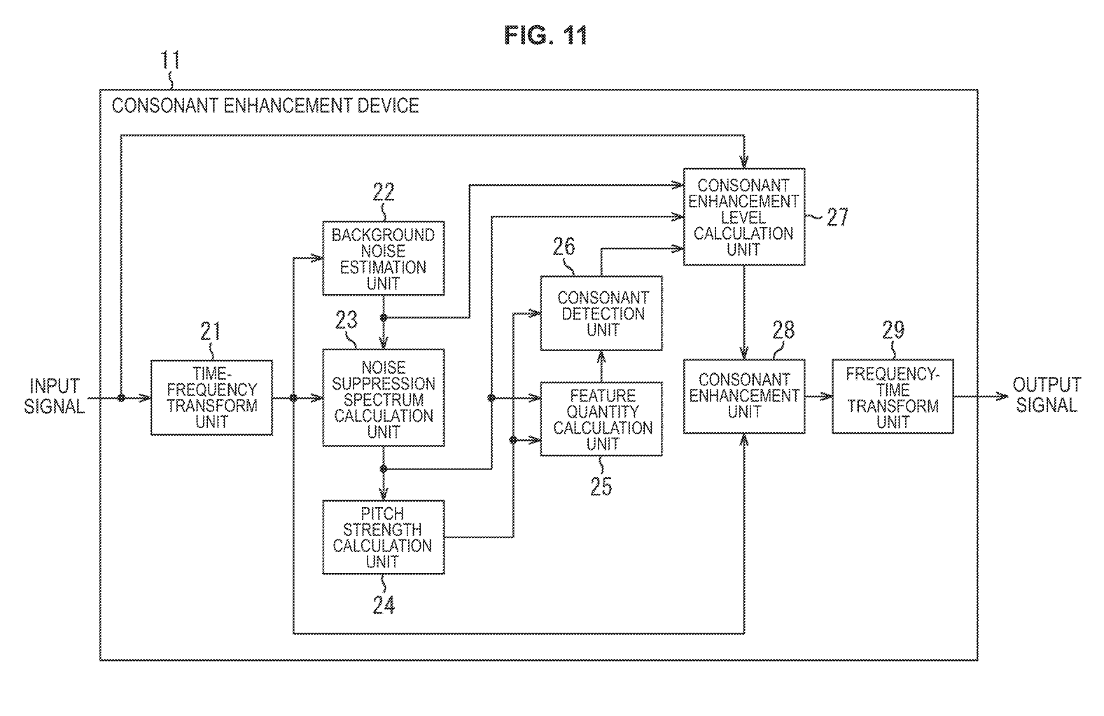

In such a case, the consonant enhancement device 11 is configured, for example, as shown in FIG. 11. In FIG. 11, portions corresponding to those in FIG. 1 are denoted with the same reference numerals, and repeated explanation of these portions is appropriately omitted.

The consonant enhancement device 11 shown in FIG. 11 has the same configuration as the consonant enhancement device 11 shown in FIG. 1, except that the supplied input signal is also supplied to the consonant enhancement level calculation unit 27.

In the consonant enhancement device 11 shown in FIG. 11, the consonant enhancement level calculation unit 27 calculates a vowel part power in a time domain or a power of the input signal of the current frame which is regarded to be a consonant frame based on the supplied input signal. Thus, the enhancement amount shown in Equation (5) is calculated from the input signal that is a time signal. In addition, for example, the power of the input signal may be root mean square (RMS) or the like.

In addition, the time-frequency transform unit 21 supplies the input spectrum obtained by performing the time-frequency transform to the background noise estimation unit 22, the noise suppression spectrum calculation unit 23, and the consonant enhancement unit 28.

<Modification 2 of First Embodiment>

<Exemplary Configuration of Consonant Enhancement Device>

Furthermore, while it has been described above that the pitch strength of an input signal is calculated based on the noise suppression spectrum, the pitch strength may be calculated in a time domain based on the input signal.

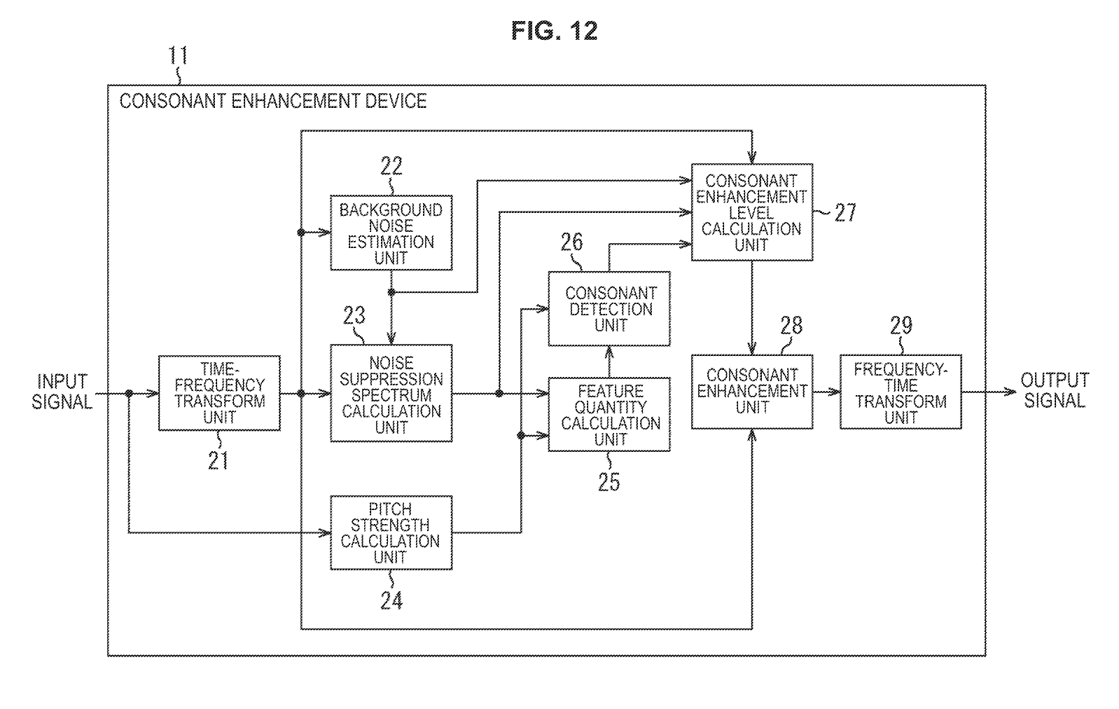

In such a case, the consonant enhancement device 11 is configured, for example, as shown in FIG. 12. In FIG. 12, portions corresponding to those in FIG. 1 are denoted with the same reference numerals, and repeated explanation of these portions is appropriately omitted.

The consonant enhancement device 11 shown in FIG. 12 has the same configuration as the consonant enhancement device 11 shown in FIG. 1, except that the supplied input signal is also supplied to the pitch strength calculation unit 24.

In the consonant enhancement device 11 shown in FIG. 12, the pitch strength calculation unit 24 calculates the pitch strength by determining the autocorrelation of the input signal that is the supplied time signal, and supplies the calculated pitch strength to the feature quantity calculation unit 25 and the consonant detection unit 26. In other words, in the pitch strength calculation unit 24, in a time domain, a value of an autocorrelation coefficient calculated based on the input signal is set as the pitch strength as it is without any change.

In addition, the noise suppression spectrum calculation unit 23 supplies the noise suppression spectrum obtained by noise suppression to the feature quantity calculation unit 25 and the consonant enhancement level calculation unit 27.

<Modification 3 of First Embodiment>

<Exemplary Configuration of Consonant Enhancement Device>

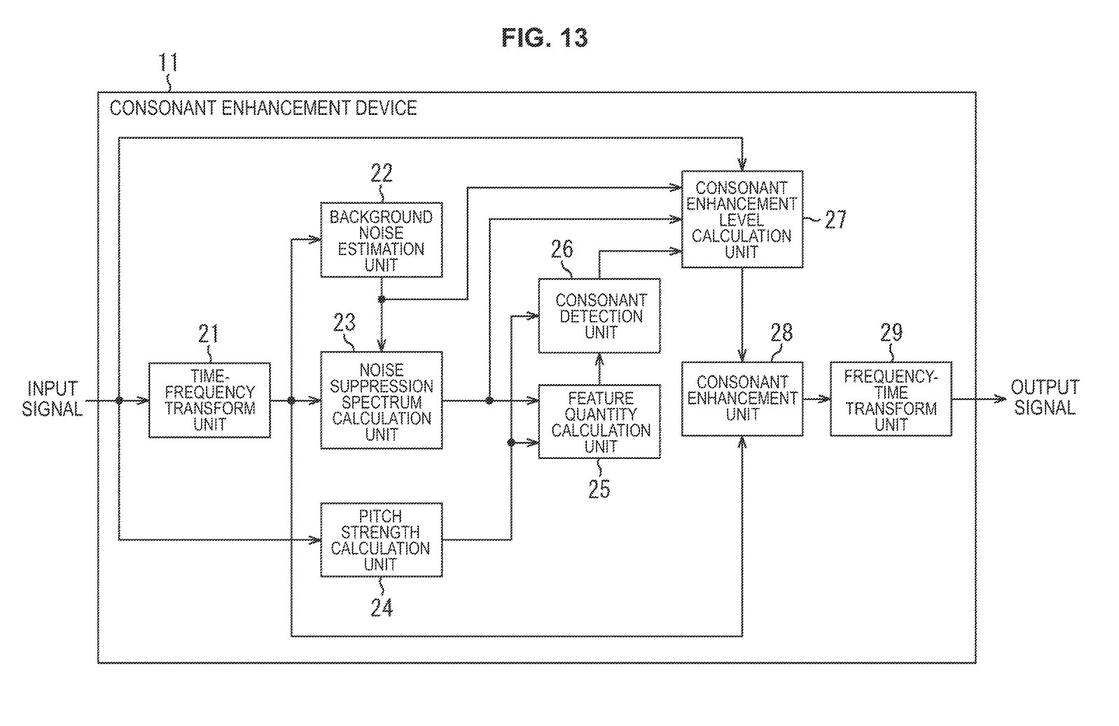

Furthermore, both enhancement amount and pitch strength may be calculated in a time domain. In such a case, a consonant enhancement device 11 is configured, for example, as shown in FIG. 13. In FIG. 13, portions corresponding to those in FIG. 1 are denoted with the same reference numerals, and repeated explanation of these portions is appropriately omitted.

The consonant enhancement device 11 shown in FIG. 13 has the same configuration as the consonant enhancement device 11 shown in FIG. 1, except that the supplied input signal is supplied to the pitch strength calculation unit 24 and the consonant enhancement level calculation unit 27 in addition to the time-frequency transform unit 21.

In the consonant enhancement device 11 shown in FIG. 13, the time-frequency transform unit 21 supplies the input spectrum obtained by performing the time-frequency transform to the background noise estimation unit 22, the noise suppression spectrum calculation unit 23, and the consonant enhancement unit 28.

The pitch strength calculation unit 24 calculates pitch strength based on the input signal that is the supplied time signal and supplies the calculated pitch strength to the feature quantity calculation unit 25 and the consonant detection unit 26. In addition, the noise suppression spectrum calculation unit 23 supplies the noise suppression spectrum obtained by noise suppression to the feature quantity calculation unit 25 and the consonant enhancement level calculation unit 27.

Moreover, the consonant enhancement level calculation unit 27 calculates a vowel part power or a power of the input signal of the current frame which is regarded to be a consonant frame based on the supplied input signal. In other words, the enhancement amount is calculated in a time domain.

### Second Embodiment

### Exemplary Configuration of Consonant Detection Device

Furthermore, the example in which the present technology is applied to the consonant enhancement device for detecting a consonant part from the input signal and enhancing a spectrum of the consonant has been described above. However, embodiments of the present technology may be applied to a consonant detection device configured to detect a consonant frame from the input signal.

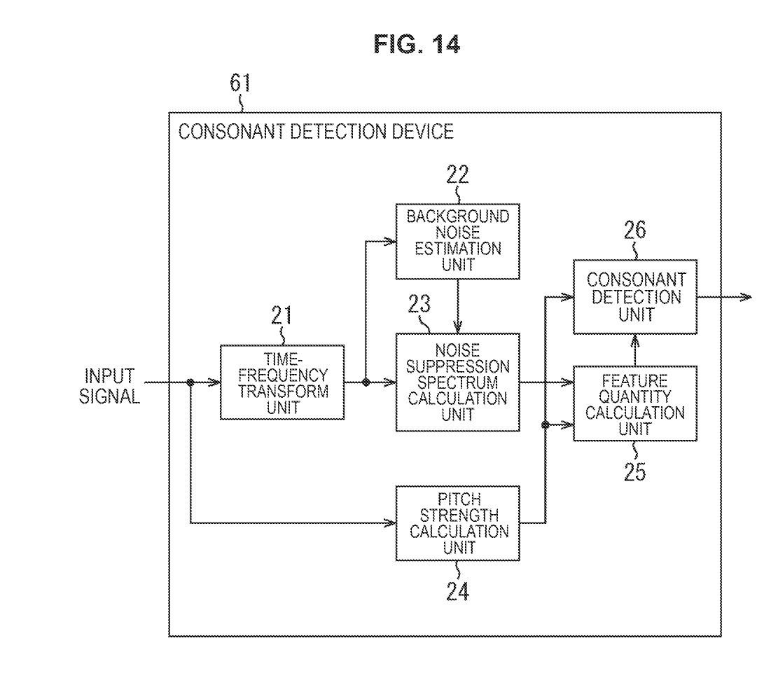

In such a case, the consonant detection device is configured, for example, as shown in FIG. 14. In FIG. 14, portions corresponding to those in FIG. 1 are denoted with the same reference numerals, and repeated explanation of these portions is appropriately omitted.

The consonant detection device 61 shown in FIG. 14 is configured to include the time-frequency transform unit 21, the background noise estimation unit 22, the noise suppression spectrum calculation unit 23, the pitch strength calculation unit 24, the feature quantity calculation unit 25, and the consonant detection unit 26.

The time-frequency transform unit 21 performs a time-frequency transform on the supplied input signal and supplies the resulting input spectrum to the background noise estimation unit 22 and the noise suppression spectrum calculation unit 23.

The background noise estimation unit 22 performs background noise estimation based on the input spectrum supplied from the time-frequency transform unit 21 and supplies the resulting background noise spectrum to the noise suppression spectrum calculation unit 23. The noise suppression spectrum calculation unit 23 obtains a noise suppression spectrum based on the input spectrum supplied from the time-frequency transform unit 21 and the background noise spectrum supplied from the background noise estimation unit 22, and supplies the obtained noise suppression spectrum to the feature quantity calculation unit 25.

The pitch strength calculation unit 24 calculates pitch strength in a time domain based on an input signal that is the supplied time signal, and supplies the calculated pitch strength to the feature quantity calculation unit 25 and the consonant detection unit 26.

The feature quantity calculation unit 25 calculates a feature quantity based on the noise suppression spectrum supplied from the noise suppression spectrum calculation unit 23 or based on the noise suppression spectrum and the pitch strength supplied from the pitch strength calculation unit 24, and supplies the calculated feature quantity to the consonant detection unit 26.

The consonant detection unit 26 detects a consonant section of an input signal based on the pitch strength supplied from the pitch strength calculation unit 24 and the feature quantity supplied from the feature quantity calculation unit 25, and outputs a result of the detection to the subsequent stage. In other words, in the consonant detection unit 26, for example, a process that is similar to the consonant detection process described above with reference to the flowchart of FIG. 9 is performed.

In this way, even in the consonant detection device 61, as in the case of the constant enhancement device 11, it is possible to detect a consonant from an input signal with higher accuracy.

<Modification 1 of Second Embodiment>

<Exemplary Configuration of Consonant Detection Device>

Further, in the consonant detection device 61 shown in FIG. 14, the example in which pitch strength is obtained in a time domain has been described, however the pitch strength may be obtained in a frequency domain.

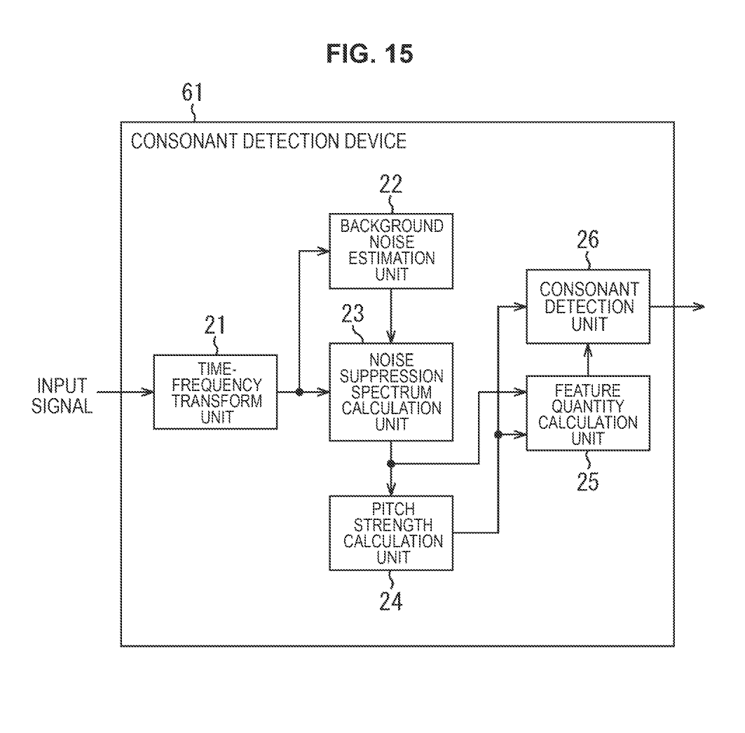

In such a case, the consonant detection device 61 is configured, for example, as shown in FIG. 15. In FIG. 15, portions corresponding to those in FIG. 14 are denoted with the same reference numerals, and repeated explanation of these portions is appropriately omitted.

The consonant enhancement device 61 shown in FIG. 15 has the same configuration as the consonant enhancement device 61 shown in FIG. 14, except that the input signal is supplied to only the time-frequency transform unit 21 and the noise suppression spectrum is supplied from the noise suppression spectrum calculation unit 23 to the pitch strength calculation unit 24.

The noise suppression spectrum calculation unit 23 supplies the noise suppression spectrum obtained by suppressing the background noise to the pitch strength calculation unit 24 and the feature quantity calculation unit 25.

The pitch strength calculation unit 24 calculates pitch strength of the input signal in a frequency domain based on the noise suppression spectrum supplied from the noise suppression spectrum calculation unit 23, and supplies the calculated pitch strength to the feature quantity calculation unit 25 and the consonant detection unit 26.

The series of processes described above can be executed by hardware but can also be executed by software. When the series of processes is executed by software, a program that constructs such software is installed into a computer. Here, the expression “computer” includes a computer in which dedicated hardware is incorporated and a general-purpose personal computer or the like that is capable of executing various functions when various programs are installed.

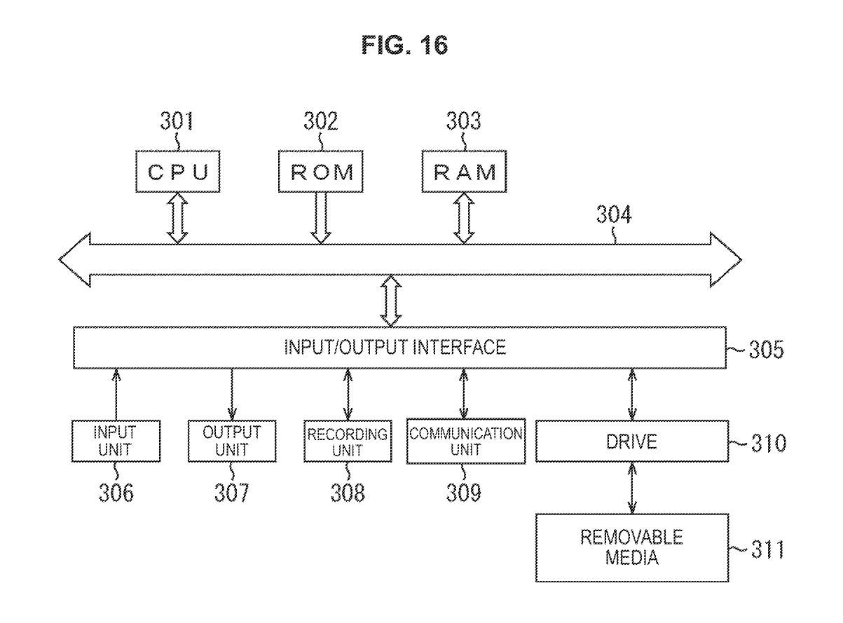

FIG. 16 is a block diagram showing a hardware configuration example of a computer that performs the above-described series of processing using a program.

In the computer, a central processing unit (CPU) 301, a read only memory (ROM) 302 and a random access memory (RAM) 303 are mutually connected by a bus 304.

An input/output interface 305 is also connected to the bus 304. An input unit 306, an output unit 307, a storage unit 308, a communication unit 309, and a drive 310 are connected to the input/output interface 305.

The input unit 306 is configured from a keyboard, a mouse, a microphone, an imaging device or the like. The output unit 307 is configured from a display, a speaker or the like. The storage unit 308 is configured from a hard disk, a non-volatile memory or the like. The communication unit 309 is configured from a network interface or the like. The drive 310 drives a removable media 311 such as a magnetic disk, an optical disk, a magneto-optical disk, a semiconductor memory or the like.

In the computer configured as described above, the CPU 301 loads a program that is stored, for example, in the storage unit 308 onto the RAM 303 via the input/output interface 305 and the bus 304, and executes the program. Thus, the above-described series of processing is performed.

Programs to be executed by the computer (the CPU 301) are provided being recorded in the removable media 311 which is a packaged media or the like. Also, programs may be provided via a wired or wireless transmission medium, such as a local area network, the Internet or digital satellite broadcasting.

In the computer, by inserting the removable media 311 into the drive 310, the program can be installed in the storage unit 308 via the input/output interface 305. Further, the program can be received by the communication unit 309 via a wired or wireless transmission media and installed in the storage unit 308. Moreover, the program can be installed in advance in the ROM 302 or the storage unit 308.

It should be noted that the program to be executed by a computer may be a program that is processed in time series according to the sequence described in this specification or a program that is processed in parallel or at necessary timing such as upon calling.

The embodiment of the present technology is not limited to the above-described embodiment. It should be understood by those skilled in the art that various modifications, combinations, sub-combinations and alterations may occur depending on design requirements and other factors insofar as they are within the scope of the appended claims or the equivalents thereof.

For example, the present disclosure can adopt a configuration of cloud computing which processes by allocating and connecting one function by a plurality of apparatuses through a network.

Further, each step described by the above mentioned flow charts can be executed by one apparatus or by allocating a plurality of apparatuses.

In addition, in the case where a plurality of processes is included in one step, the plurality of processes included in this one step can be executed by one apparatus or by allocating a plurality of apparatuses.

Additionally, the present technology may also be configured as below.

(1) A sound processing device including:

a background noise estimation unit configured to estimate a background noise of an input signal;

a noise suppression unit configured to suppress the background noise of the input signal based on a result obtained by estimating the background noise;

a feature quantity calculation unit configured to calculate a feature quantity based on the input signal in which the background noise is suppressed; and

a consonant detection unit configured to detect a consonant from the input signal based on the feature quantity.

(2) The sound processing device according to (1),

wherein the background noise estimation unit estimates the background noise in a frequency domain,

wherein the noise suppression unit obtains a noise suppression spectrum by suppressing the background noise included in an input spectrum obtained from the input signal, and

wherein the feature quantity calculation unit calculates the feature quantity based on the noise suppression spectrum.

(3) The sound processing device according to (2), wherein the background noise estimation unit estimates the background noise by obtaining an average value of a previous input spectrum.
(4) The sound processing device according to (2) or (3), further including:

a consonant enhancement unit configured to enhance the input spectrum for a frequency in which a value of the noise suppression spectrum is greater than a value obtained by multiplying a background noise spectrum by a constant, the background noise spectrum being obtained by estimation of the background noise.

(5) The sound processing device according to (4), wherein the consonant enhancement unit enhances the input spectrum with a predetermined enhancement amount.
(6) The sound processing device according to (4), further including:

a consonant enhancement level calculation unit configured to calculate an enhancement amount based on a ratio of a current power of the input signal to an average value of a power of a previous vowel part of the input signal,

wherein the consonant enhancement unit enhances the input spectrum with the enhancement amount.

(7) The sound processing device according to (5) or (6), wherein an interpolation of the enhancement amount is performed with respect to a frequency direction.
(8) The sound processing device according to any one of (2) to (7), wherein the noise suppression unit obtains the noise suppression spectrum by using a spectral subtraction method.
(9) The sound processing device according to any one of (2) to (8), wherein a pitch strength of the input signal is further used as the feature quantity, and

wherein the consonant detection unit detects a consonant from the input signal on a basis of the pitch strength as the feature quantity and the feature quantity calculated based on the noise suppression spectrum.

(10) The sound processing device according to (9), wherein the pitch strength is represented by a degree to which a peak of the noise suppression spectrum is generated in a position of a pitch frequency and a position of a harmonic frequency of the pitch frequency.
(11) The sound processing device according to (9), wherein the pitch strength is an autocorrelation coefficient value of the input signal.
(12) The sound processing device according to any one of (2) to (11), wherein the feature quantity calculation unit divides a frequency band of the noise suppression spectrum into a plurality sub-bands, and calculates the feature quantity based on a representative value of the noise suppression spectrum in the sub-bands.
(13) The sound processing device according to (12), wherein the noise suppression spectrum is a power spectrum.
(14) The sound processing device according to (12), wherein the noise suppression spectrum is an amplitude spectrum.
(15) The sound processing device according to any one of (12) to (14), wherein the representative value is an average value of the noise suppression spectrum in the sub-bands.
(16) The sound processing device according to any one of (12) to (14), wherein the representative value is a maximum value of the noise suppression spectrum in the sub-bands.
(17) The sound processing device according to any one of (12) to (16), wherein the feature quantity calculation unit calculates a time difference value between the representative values of the sub-bands in the noise suppression spectrum as the feature quantity.

What is claimed is:

1. A sound processing device comprising:
a background noise estimation unit configured to estimate a background noise of an input signal;
a noise suppression unit configured to suppress the background noise of the input signal based on a result obtained by estimating the background noise;
a feature quantity calculation unit configured to calculate a feature quantity based on the input signal in which the background noise is suppressed; and
a consonant detection unit configured to detect a consonant from the input signal based on the feature quantity.

2. The sound processing device according to claim 1,
wherein the background noise estimation unit estimates the background noise in a frequency domain,
wherein the noise suppression unit obtains a noise suppression spectrum by suppressing the background noise included in an input spectrum obtained from the input signal, and
wherein the feature quantity calculation unit calculates the feature quantity based on the noise suppression spectrum.

3. The sound processing device according to claim 2, wherein the background noise estimation unit estimates the background noise by obtaining an average value of a previous input spectrum.

4. The sound processing device according to claim 3, further comprising:
a consonant enhancement unit configured to enhance the input spectrum for a frequency in which a value of the noise suppression spectrum is greater than a value obtained by multiplying a background noise spectrum by a constant, the background noise spectrum being obtained by estimation of the background noise.

5. The sound processing device according to claim 4, wherein the consonant enhancement unit enhances the input spectrum with a predetermined enhancement amount.

6. The sound processing device according to claim 4, further comprising:
a consonant enhancement level calculation unit configured to calculate an enhancement amount based on a ratio of a current power of the input signal to an average value of a power of a previous vowel part of the input signal,
wherein the consonant enhancement unit enhances the input spectrum with the enhancement amount.

7. The sound processing device according to claim 6, wherein an interpolation of the enhancement amount is performed with respect to a frequency direction.

8. The sound processing device according to claim 2, wherein the noise suppression unit obtains the noise suppression spectrum by using a spectral subtraction method.

9. The sound processing device according to claim 2, wherein a pitch strength of the input signal is further used as the feature quantity, and
wherein the consonant detection unit detects a consonant from the input signal on a basis of the pitch strength as the feature quantity and the feature quantity calculated based on the noise suppression spectrum.

10. The sound processing device according to claim 9, wherein the pitch strength is represented by a degree to which a peak of the noise suppression spectrum is generated in a position of a pitch frequency and a position of a harmonic frequency of the pitch frequency.

11. The sound processing device according to claim 9, wherein the pitch strength is an autocorrelation coefficient value of the input signal.

12. The sound processing device according to claim 2, wherein the feature quantity calculation unit divides a frequency band of the noise suppression spectrum into a plurality sub-bands, and calculates the feature quantity based on a representative value of the noise suppression spectrum in the sub-bands.

13. The sound processing device according to claim 12, wherein the noise suppression spectrum is a power spectrum.

14. The sound processing device according to claim 12, wherein the noise suppression spectrum is an amplitude spectrum.

15. The sound processing device according to claim 12, wherein the representative value is an average value of the noise suppression spectrum in the sub-bands.

16. The sound processing device according to claim 12, wherein the representative value is a maximum value of the noise suppression spectrum in the sub-bands.

17. The sound processing device according to claim 12, wherein the feature quantity calculation unit calculates a time difference value between the representative values of the sub-bands in the noise suppression spectrum as the feature quantity.

18. A sound processing method comprising:
estimating a background noise of an input signal;
suppressing the background noise of the input signal based on a result obtained by estimating the background noise;
calculating a feature quantity based on the input signal in which the background noise is suppressed; and
detecting a consonant from the input signal based on the feature quantity.

19. A program for causing a computer to execute a process of:
estimating a background noise of an input signal;
suppressing the background noise of the input signal based on a result obtained by estimating the background noise;
calculating a feature quantity based on the input signal in which the background noise is suppressed; and
detecting a consonant from the input signal based on the feature quantity.
